(19) United States
(12) Patent Application Publication
(10) Pub. No.: US 2007/0211562 A1
(43) Pub. Date: Sep. 13, 2007

(54) Combination straw, muddler and stirrer

(76) Inventor: Andrew J. Pitsis, Sydney (AU)

Correspondence Address: MICHAEL MOLINS;MOLINS & CO., SUITE 5, LEVEL 6, 139 MACQUARIE ST, SYDNEY NSW, 2000, omitted

(21) Appl. No.: 11/713,657

(22) Filed: Mar. 5, 2007

(30) Foreign Application Priority Data
Mar. 7, 2006 (AU) 2006901135

(51) Int. Cl. A47J 43/10

(52) U.S. Cl. 366/129; 239/33

(57) ABSTRACT

Disclosed in this specification is a device that is a combination straw, muddler, and stirrer. The device comprises a hollow tube that ends in a flange carrying spikes for crushing fruit pieces or other flavour ingredients. Optional stirring ribs may be provided to facilitate stirring. An entire or a partial length of the tube may be manufactured to have round or polyhedral cross sections, providing for flat surfaces on which texts or symbols may be positioned.

### FIELD OF THE INVENTION

The invention pertains to straws and more particularly to a drinking straw that also serves as a muddler and stirrer.

### BACKGROUND OF THE INVENTION

A drinking straw is a hollow tube that can be used to suck liquids into the mouth. A muddler is a bar tool that can be used to extract flavours from beverage ingredients such as citrus fruit pieces, by braking them up or crushing them. Although many beverages are served with a straw or consumed through one, the straw does not make an effective stirrer, particularly when a glass is filled to the brim or close to it. A paddle-type stirrer is good for this purpose but a beverage can not be sipped through it. The muddler is effective for extracting flavour from fruit and for dispersing fruit pieces into a beverage, but does not serve particularly well as a stirrer and cannot be used as a straw.

### OBJECTS AND SUMMARY OF THE INVENTION

It is an object of the invention to provide a drinking straw that also has the attributes of a muddler.

It is also an object of the invention to provide a drinking straw that also has the attributes of both a muddler and a rotary stirrer.

Accordingly, there is provided a hollow tube that terminates in a flange. The flange has a lower surface from which extends a plurality of projections.

In preferred embodiments, stirring ribs extend between the flange and the outer surface of the tube.

In particularly preferred embodiments, the projections are spikes.

In some embodiments of the invention, some portion of the tube has an exterior surface that is, in part, flat.

### BRIEF DESCRIPTION OF THE DRAWING FIGURES

In order that the invention be better understood reference is now made to the following drawing figures in which:

FIG. 1 is a cross section through a straw, muddler and stirrer of the present invention;

FIG. 2 is a cross sectional view of an alternate embodiment of the invention that can serve as a rotary stirrer;

FIG. 3 is a bottom plan view of a device of the type depicted in FIGS. 1 and 2;

FIG. 4 is a bottom plan view of a device such as the one depicted in FIG. 3 where at least part of the tube is square in cross section; and

FIG. 5 is a side elevation of an alternate embodiment of the invention having both polyhedral and round cross sections.

### BEST MODE AND OTHER EMBODIMENTS OF THE INVENTION

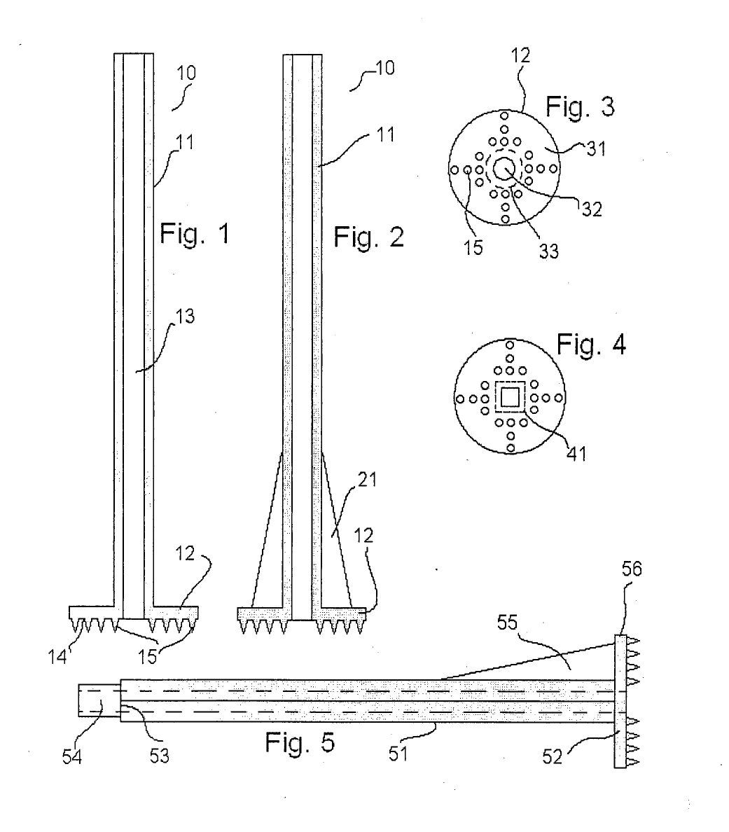

As shown in FIG. 1, a device made in accordance with the teachings of the present invention 10 comprises a hollow tube 11 that is adapted to act as a drinking straw. The hollow tube 11 terminates in a flange 12. In preferred embodiments, the flange is round but it may assume any number of shapes. The central bore 13 of the tube 11 passes through the flange 12. The underside 14 of the flange has projections 15 that extend from it. In preferred embodiments, these projections are small spikes that can assist with breaking apart a fruit such as a slice of citrus fruit commonly found in beverages such as cocktails. Because the device 10 is used as a drinking straw it must be long enough to extend past the rim of a drinking glass when the flange 12 is resting on the bottom of the glass. The inner and outer diameters of the tube 11 are provided to make sipping a drink convenient. Accordingly, the device depicted in FIG. 1 may be used as a drinking straw or a muddler. Because of the surface area of the flange 12, reciprocating the device vertically creates a stirring or mixing effect in the glass.

This stirring effect can be enhanced by providing the device 10 with stirring ribs 21 as shown in FIG. 2. The stirring ribs 21 may be one or more in number and are preferably evenly spaced around the circumference of the tube 11. The ribs 21 extend between the flange 12 and at least a lower portion of the tube 11. In this way the rotary stirring action of the device is enhanced because it can be spun between the fingers and not just reciprocated vertically. This action is further enhanced because the tube 11 is round and can be spun between the fingers of one hand.

As shown in FIG. 3, the underside 31 of the flange 12 includes a central opening 32 that leads into the tube's bore 13. As suggested by this illustration, both the internal bore 13 and the outer surface 33 of the tube 11 are round. This view of the underside of the flange also shows an arrangement of spikes or projections 15, it being understood that this particular pattern represents only an example and not a limiting feature of the invention.

As shown in FIG. 4 the external surface 41 of the tube 11 may be polyhedral, in this example, square. A polyhedral or square tube has the advantages of possessing flat sides along its length that may be used for locating, advertising or promotional words, slogans, symbols and the like. It will be understood that the shape of the exterior of the tube 11 may be triangular in cross section, square, or otherwise polyhedral. Tubular shapes of this kind are easier to twirl than flat or paddle shapes.

A further example is depicted in FIG. 5. In this example, the hollow tube 51 is square in cross section from the upper surface of the flange 52 to a location 53 near the upper end of the device. In order to make drinking through the device more convenient, the upper end of the tube 51 is made round in cross section. This upper end 54 need only be on the order of 1 cm long but may be considerably longer, if required to desired. This example also illustrates a stirring rib 55 that extends almost to the outer edge 56 of the flange 52. The stirring rib 55 also presents a flat surface on either side of it allowing additional symbols or text to be positioned on the flat surfaces of the one or more stirring ribs 55. More than one rib may be provided.

While the present invention has been disclosed with reference to particular details of construction, these should be understood as having been provided by way of example and not as limitations to the scope or spirit of the invention. In particular, the precise cross sectional shape of the tube 11 is not considered an essential element of the invention. It is important that the tube 11 be hollow but it's external configuration may be determined by any number of factors both aesthetic and functional. It will also be understood that the size, shape, number and even presence of extending projections on the underside of the flange represent design choices over which there is a wide range of latitude.

What is claimed is:

1. A combination straw, muddler, and stirrer, comprising:
a hollow tube terminating in a flange; wherein
a central bore of the tube passes through the flange.

2. The device of claim 1, wherein,
an underside of the flange has a plurality of projections.

3. The device of claim 2, wherein,
the projections are spikes.

4. The device of claim 1, further comprising, one or more stirring ribs extending between a lower portion of the tube and the flange.

5. The device of claim 4, wherein,
the stirring rib extends almost to an outer edge of the flange.

6. The device of claim 4, wherein,
the stirring rib has a flat surface.

7. The device of claim 4, wherein,
the stirring ribs are evenly spaced around a circumference of the tube.

8. The device of claim 1, wherein,
the flange is round.

9. The device of claim 1, wherein,
an outer surface of the tube is round.

10. The device of claim 1, wherein,
at least a portion of an outer surface of the tube is a polyhedral portion, and the tube has a flat side.

11. The device of claim 10, wherein,
the tube comprises an upper end that is round in cross section.

12. The device of claim 11, wherein,
the upper end is approximately 1 cm.

13. The device of claim 10, wherein,
the flat side is adapted for locating words, slogans, or symbols.

14. The device of claim 10, wherein,
the polyhedral portion of the tube is triangular in cross section.

15. The device of claim 10, wherein,
the polyhedral portion of the tube is square in cross section.
